(19) United States
(12) Patent Application Publication
(10) Pub. No.: US 2011/0002757 A1
(43) Pub. Date: Jan. 6, 2011

(54) Hay bale grabber farm implement

(76) Inventor: Steven Mark Taylor, Macomb, OK (US)

Correspondence Address: Steven Mark Taylor, 31300 Hwy 102, Macomb, OK, 74852, US

(21) Appl. No.: 12/387,741

(22) Filed: Jul. 1, 2009

(51) Int. Cl. A01D 90/00

(52) U.S. Cl. 414/24.5

(57) ABSTRACT

The implement has a main square frame that attaches to a front end loader on a tractor. The implement has an arm that protrudes out 41″ from the top of the frame. The arm has a 9″ head that has two 12″ teeth protruding downward. The teeth are 11″ apart a hydraulic cylinder attaches to the main frame. The cylinder moves the arm up and down. The hydraulic cylinder hoses will hook into the back of the tractor's hydraulic system, this allows the operator to maneuver the implement using the hydraulic controls inside the cab. The hay grabber allows you to pick up round bales of hay from any side and load or unload the bales. This

### BACKGROUND

This version of the invention is concerned with the field of farm implements. More specifically, this version of the invention is concerned with a hay bale grabber farm implement for transporting, stacking, and storing hay bales.

### PRIOR ART

Hay bales and other similar livestock feed items are generally configured into large, cumbersome, and weighty segments or sections in order to provide a significant quantity of material in each segment or section. A typical hay bale, for instance, is shaped into a cylinder several feet high and several feet in diameter.

During non-use, the hay bale is transported from a first location to a second location for storage. Storage of hay bales involves stacking the hay bales into a column several hay bales high so as to minimize the amount of space required for storage. This necessity to minimize storage space becomes acute when the storage area, such as a barn or other out building, is limited in size or available storage area.

A typical hay bale is generally too large and heavy for a farm hand to transport and stack into columns without the aid of mechanical assistance. Furthermore, the hay bales must be stacked with care so they are not damaged during stacking from other hay bales or a farm hand and are not damaged after stacking from the weight of any hay bales improperly stacked. The preferred method of stacking hay bales into columns consists of lifting successive hay bales from a ground or support surface into a column and placing successive hay bales on top of each other until the column of hay bales has reached the appropriate height without touching or stepping upon hay bales previously stacked.

The subject of the instant invention introduces a hay bale grabber farm implement that is releasably attached to the fork or lifting apparatus of a conventional farm tractor. The hay bale grabber farm implement, attached to the tractor, can be raised from a ground or support surface, pivoted forward or rearward, and lowered onto the ground or support surface. The hay bale grabber farm implement is connected to a hydraulic system on the farm tractor, which powers the hay bale grabber farm implement to open around or close upon a hay bale so as to grasp the hay bale, transport the hay bale to a storage area, and release the hay bale onto a ground or support surface or onto a column of several hay bales. Unlike a spear loader, the hay bale grabber farm implement can stack hay bales on the sides thereof into a column. A column of hay bales stacked as such is more sturdy and stable than a column of hay bales stacked by the spear loader.

### DISCUSSION OF THE PRIOR ART

The existence of a device to grasp, transport, and stack hay bales into columns is unknown at the present time. For example, numerous designs for hay and hay bale transport and grasping devices have been provided in the prior art. Even though these designs may be suitable for the specific individual purposes to which they address, they would not be suitable for the purposes of the present version of the invention. These designs are exemplified by the following patents:
U.S. Pat. No. 4,318,653, Hay Loader, issued to Benefield et al. on 9 Mar. 1982;
U.S. Pat. No. 4,583,900, Round Hay Bale Handling Apparatus Having At Least One Screw Spear, issued to Cooley on 22 Apr. 1986;
U.S. Pat. No. 4,597,703, Bale Handling And Hay Distributing Apparatus, issued to Bartolini on 1 Jul. 1986;
U.S. Pat. No. 5,129,775, Bale Handling Apparatus, issued to Coats et al. on 14 Jul. 1992;
U.S. Pat. No. 5,178,505, Three-Point Hitch Attachment With Hay Mover, issued to Smith on 12 Jan. 1993;
U.S. Pat. No. 5,833,424, Round Hay Bale Lifter, issued to Bales on 10 Nov. 1998; and
U.S. Pat. No. 6,840,730, Bale Moving Apparatus, issued to Noualy on 11 Jan. 2005.

As illustrated by the background art, efforts are continuously being made in an attempt to develop devices for transporting and storing hay bales. No prior effort, however, provides the benefits attendant with the present invention.

As such, it may be appreciated that there is a continuing need for a new and improved hay bale grabber farm implement that can be releasably attached to the fork or lifting device of a conventional farm tractor to transport and stack one or hay bales into a column up to four hay bales high without damaging the hay bales. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### SUMMARY

The present version of the invention, which will be described in greater detail hereinafter, relates to the field of farm implements. More specifically, this version of the invention is concerned with a hay bale grabber farm implement for transporting, stacking, and storing hay bales. My version of the invention overcomes all of the shortcomings listed previously, in addition to novel aspects that will be described in detail hereinafter.

Described briefly, according to a typical embodiment, the invention presents a hay bale grabber farm implement for grasping and moving hay bales from a first location to a second location for stacking and storing one or more bales of hay. The hay bale grabber farm implement is comprised of a rectangular frame having first and second opposed horizontal tubular members and first and second opposed vertical tubular members. Rectangular plates with apertures are located on opposed sides of each vertical tubular member at the lower ends thereof.

Two tines are located medially on the second horizontal tubular member and extend horizontally therefrom. A tubular member is located medially on the first horizontal tubular member and extends therefrom in perpendicular relation. An arm is pivotally attached at one end thereof to the first horizontal tubular member of the frame. The arm can be raised and lowered with respect to the frame. It is comprised of a first, longer tubular member, and a second shorter tubular member, said second shorter tubular connected to the first tubular member in perpendicular relation. Two tines are located medially on the second shorter tubular member and extend downwardly therefrom toward the tines extending from the second horizontal tubular member of the frame.

A hydraulic cylinder is connected in pivoting engagement at a first end thereof to the tubular member located medially on the first horizontal tubular member of the frame and at a second end thereof to the longer tubular member of the arm. The hydraulic cylinder consists of an outer cylindrical member and a reciprocating rod that extends from and retracts into the outer cylindrical member. Two nipples are located on the exterior of the outer cylindrical member and receive pneumatic hoses for delivery of hydraulic fluid to the hydraulic cylinder. The flow of hydraulic fluid causes the hydraulic cylinder to retract or extend the internal reciprocating rod so as to raise or lower, respectively, the arm.

The hay bale grabber farm implement and various components thereof are fabricated of material that is durable, rigid, and resistant to oxidation and corrosion, such as steel coated with an outer protective layer, stainless steel, aluminum, various composite materials and the like.

The tubular members of the fork or lifting device of a farm tractor are positioned between the rectangular plates located on opposed sides of the vertical tubular members of the frame. The farm tractor raises or lowers the tubular members of the fork or lifting device to raise or lower the hay bale grabber farm implement or extend or retract the tubular members to pivot forward or rearward the hay bale grabber farm implement upon the rectangular plates.

The farm tractor with the hay bale grabber farm implement attached as such uses flow of hydraulic fluid delivered to the hydraulic cylinder to raise the arm above a hay bale and then positions the hay bale grabber farm implement upon a ground or support surface next to the hay bale. The farm tractor pushes or otherwise moves the hay bale grabber farm implement until the pair of tines extending from the second horizontal tubular member of the frame penetrates and grasps the hay bale. At that point, the farm tractor lowers the arm until the pair of tines extending downwardly therefrom penetrates and grasps the hay bale. When the hay bale is firmly grasped within and between the two pairs of tines, the tractor can raise the hay bale secured within the hay bale grabber farm implement for transport to a barn or other out building for stacking into columns and storage.

My invention, therefore, resides not in any one of these features per se, but rather in the particular combination of all of them herein disclosed. It is distinguished from the prior art in this particular combination of all of its structures for the functions specified.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low-cost, easy-to-manufacture, and easy-to-market hay bale grabber farm implement.

A further object of my version of the invention is to provide an easy-to-use and versatile hay bale grabber farm implement.

A significant object of the invention is to provide a hay bale grabber farm implement comprised of a rectangular frame; a first pair of tines extending horizontally from the frame; an arm pivotally attached at a first end thereof to the frame; a second pair of tines located at a second end of the arm and extending downwardly therefrom toward the first pair of tines; a hydraulic cylinder pivotally attached at a first end thereof to the frame and pivotally attached at a second thereof to the arm, said hydraulic cylinder receiving flow of hydraulic fluid from pneumatic hoses to raise and lower the arm onto a hay bale, thereby causing the two pairs of tines to penetrate and grasp the hay bale.

A final but very significant object of the invention is to provide a hay bale grabber farm implement that is releasably attached to a fork or lifting apparatus of a farm tractor for grasping and moving hay bales from a first location to a second location and stacking one or more hay bales into columns for storage.

For a better understanding of the invention, its operating advantages and the specific objects attained by its uses, reference should be made to the accompanying drawings and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is a perspective view of a hay bale grabber farm implement in accordance with the present version of the invention.

FIG. 2 is a perspective view of the hay bale grabber farm implement with an arm thereof raised upward in accordance with the present version of the invention.

FIG. 3 is a perspective view of the hay bale grabber farm implement with the arm thereof raised above a hay bale in accordance with the present version of the invention.

FIG. 4 is a perspective view of the hay bale grabber farm implement with the arm thereof lowered onto the hay bale in accordance with the present version of the invention.

### DRAWING REFERENCE NUMERALS

10 Hay Bale Grabber Farm Implement
12 Frame
14 Tubular Member
16 Tubular Member
18 Tubular Member
20 Tubular Member
22 Plate
24a Aperture
24b Aperture
26 Plate
28 Plate
30 Plate
32 Tine
34 Ear
36 Tubular Member
38 Ear
40 Arm
42 Tubular Member
44 First End
46 Second End
48 Ear
50 Tubular Member
52 Tine
54 Pin
56 Hydraulic Cylinder
58 Cylindrical Member
60 Rod
62 Ear
64 Yoke
66 Pin
68 Pin
70 Nipple
72 Hose
74 Tubular Member
76 End
78 Tubular Member
80 End
82 Hay Bale

### DESCRIPTION OF THE PREFERRED EMBODIMENT

### Description

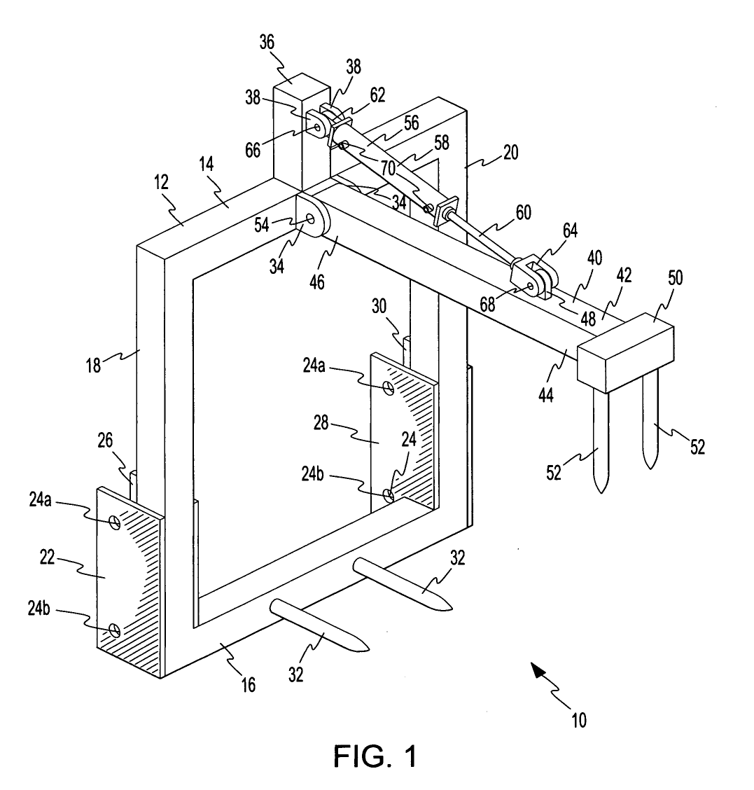

Referring now to the drawings and, in particular, to FIG. 1 wherein there is illustrated a typical embodiment of the hay bale grabber farm implement 10 for grasping and moving hay bales from a first location to a second location for stacking and storing one or more bales of hay into a column up to four bales high. The present version of the invention 10 consists of a rectangular frame 12 having an upper, horizontal tubular member 14; lower, horizontal tubular member 16; first, vertical tubular member 18, and second, vertical tubular member 20. A first plate 22 with upper 24a and lower 24b apertures is located on the exterior side of the first vertical tubular member 18 at the lower end thereof, and a second plate 26 with upper 24a and lower 24b apertures is located on the interior side of the first vertical tubular member 18 at the lower end thereof. A third plate 28 with upper 24a and lower 24b apertures is located on the interior side of the second vertical tubular member 20 at the lower end thereof, and a fourth plate 30 with upper 24a and lower 24b apertures is located on the exterior side of the second vertical tubular member 20 at the lower end thereof.

Two tines 32 are located medially on the lower, horizontal tubular member 16 and extend therefrom for some distance. A pair of ears 34 is located medially on the upper horizontal tubular member 14, and a tubular member 36 is attached medially to the upper horizontal tubular member 14 and extends in perpendicular relation for some distance therefrom. A pair of ears 38 is located on the tubular member 36 at the upper end thereof.

An arm 40 is pivotally attached to the frame 12 at the medial portion of the upper, horizontal tubular member 14 thereof. The arm 40 is comprised of a tubular member 42 having a first end 44, second, opposed end 46, and ear 48. The ear 48 is located on the tubular member 42 proximate to the first end 44 thereof. A tubular member 50 is attached in perpendicular relation to the tubular member 42 at the first end thereof 44. Two tines 52 are located medially on the lower side of the tubular member 50 and extend therefrom for some distance. A pin 54 is inserted through the ears 34 on the upper horizontal tubular member 14 and through the tubular member 42 at the second end 46 thereof. The arm 40 pivots upward and downward upon the pin 54.

Referring again to FIG. 1, a pneumatic hydraulic cylinder 56 is connected to the tubular member 36 of the frame 12 and the arm 40. The hydraulic cylinder 56 is comprised of an outer cylindrical member 58, reciprocating rod 60, ear 62 attached to one end of the outer cylindrical member 58, and yoke 64 attached to the exterior end of the reciprocating rod 60. A first pin 66 is inserted through the ears 38 on the tubular member 36 and through the ear 62 attached to the cylindrical member 58. A second pin 68 is inserted through the yoke 64 and through the ear 48 attached to the tubular member 42 of the arm 40. Two nipples 70 are located on the exterior of the outer cylindrical member 58. A pneumatic hose is attached to each nipple 70 and delivers hydraulic fluid to the hydraulic cylinder 56. The flow of hydraulic fluid causes the hydraulic cylinder 56 to retract or extend the internal reciprocating rod 60 so as to raise or lower, respectively, the arm 40.

The hay bale grabber farm implement 10 and various components thereof are fabricated of material that is durable, rigid, and resistant to oxidation and corrosion, such as steel coated with an outer protective layer, stainless steel, aluminum, various composite materials and the like.

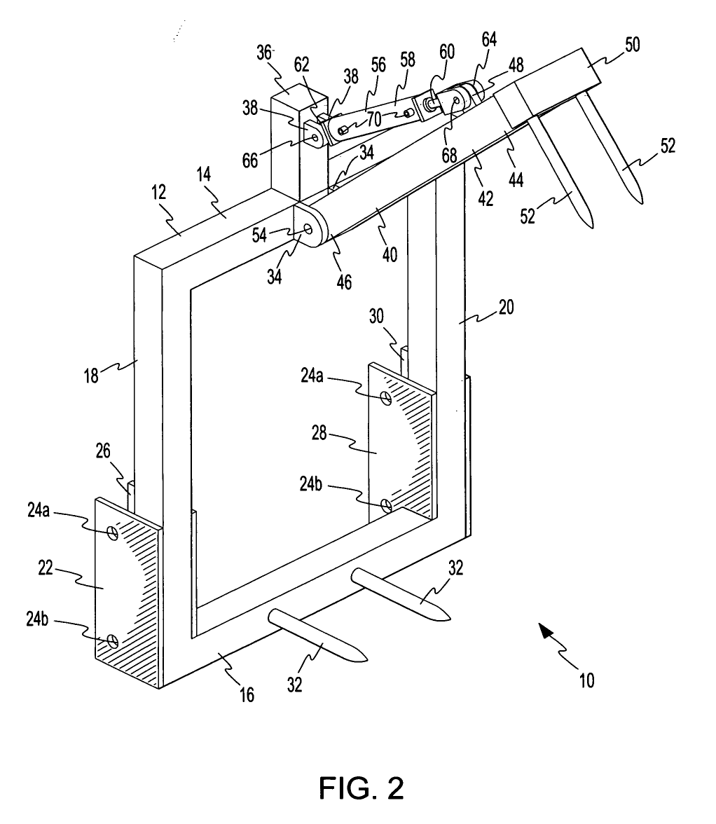

Referring to FIG. 2, therein illustrated is the hay bale grabber farm implement 10 with the arm 40 thereof in a raised position. In this configuration, the reciprocating rod 60 in response to flow of pressurized fluid within the outer cylindrical member 58 retracts within the outer cylindrical member 58. The retraction of the reciprocating rod 60 causes the arm 40 to pivot upward upon the pin 54, and the hydraulic cylinder 56 to pivot upward upon pins 66, 68.

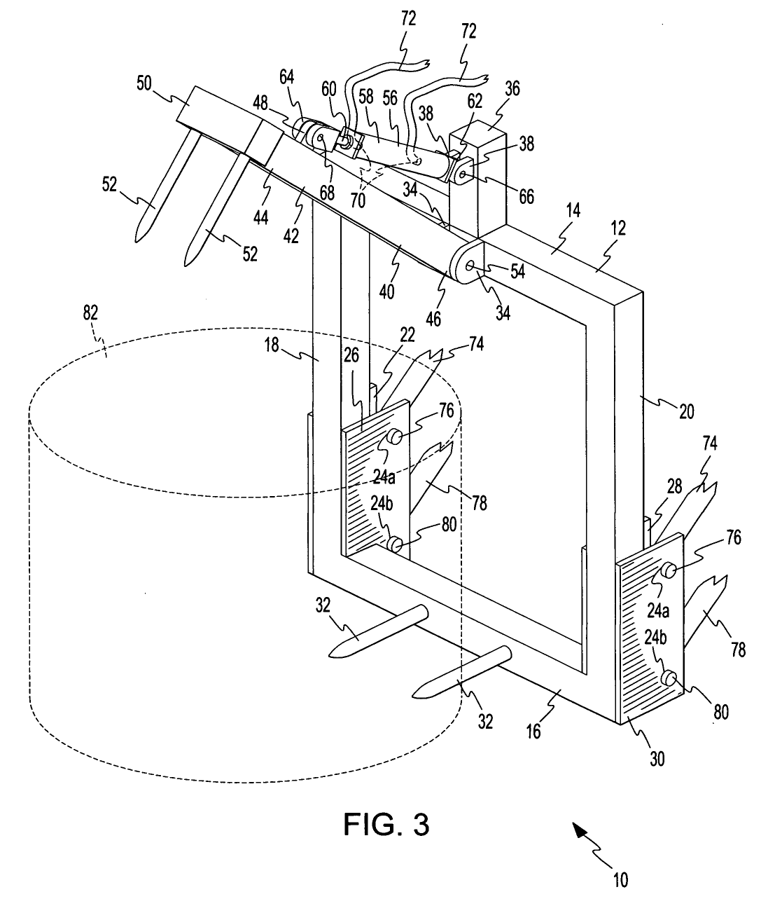

During use of the hay bale grabber farm implement 10 as shown in FIG. 3, a pneumatic hose 72 is attached at a first end thereof to each nipple 70 and at a second end thereof to a hydraulic system or similar device attached to or operating on a farm tractor (not shown). The hydraulic system creates pressurized fluid and delivers it through the pneumatic hoses 72 to the hydraulic cylinder 56. A first pair of cooperating tubular members 74 of a tractor fork is positioned between the plates 22, 26, 28, 30 with the ends 76 of said tubular members 74 occupying the upper apertures 24a of said plates 22, 26, 28, 30. A second pair of cooperating tubular members 78 of a tractor fork is positioned between the plates 22, 26, 28, 30 with the ends 80 of said tubular members 78 occupying the lower apertures 24b of said plates 22, 26, 28, 30.

When the tractor fork retracts the first pair of cooperating tubular members 74, the hay grabber implement 10 pivots rearward upon the ends 80 of the second cooperating tubular members 78 occupying the lower apertures 24b of the plates 22, 26, 28, 30. Conversely, when the tractor fork extends the first pair of cooperating tubular members 74, the hay grabber implement 10 pivots forward upon the ends 80 of the second cooperating tubular members 78 occupying the lower apertures 24b of the plates 22, 26, 28, 30.

When the tractor fork retracts the second pair of cooperating tubular members 78, the hay grabber implement 10 pivots forward upon the ends 76 of the first pair of cooperating tubular members 74 occupying the upper apertures 24a of the plates 22, 26, 28, 30. Conversely, when the tractor fork extends the second pair of cooperating tubular members 78, the hay grabber implement 10 pivots rearward upon the ends 76 of the first pair of cooperating tubular members 74 occupying the upper apertures 24a of the plates 22, 26, 28, 30.

Additionally, the hay bale grabber farm implement 10 when attached to a farm tractor as described previously can be raised from ground level to various heights above ground level.

Referring again to FIG. 3, a hay bale 82 (shown in phantom line) is situated on a ground or support surface next to the hay grabber farm implement 10. The implement 10 is also situated on the ground or support surface adjacent to the hay bale 82 at the same level as the hay bale 82. The flow of hydraulic fluid delivered through the pneumatic hoses 72 causes the hydraulic cylinder 56 to retract the reciprocating rod 60 within the outer cylindrical member 58. In response, the arm 40 pivots upward upon the pin 54 with respect to the frame 12, and the hydraulic cylinder 56 pivots upward upon pins 66, 68 with respect to the frame 12.

The tubular members 74, 78 of the tractor fork push or otherwise move the hay grabber farm implement 10 next to the hay bale 82 so that the tines 32 located on the lower, horizontal tubular member 16 of the frame 12 enter or otherwise penetrate the side of the hay bale 82. The tubular members 74, 78 of the tractor fork continue to push or otherwise move the hay grabber farm implement 10 towards the hay bale 82 until the tubular members 14, 16, 18, 20 of the frame 12 make contact with the side of the hay bale 82.

At that point, the flow of pressurized fluid delivered through the pneumatic hoses 72 causes the hydraulic cylinder 56 to extend the reciprocating rod 60 within the outer cylindrical member 58. In response, the arm 40 pivots downward upon the pin 54 with respect to the frame 12, and the hydraulic cylinder 56 pivots downward upon pins 66, 68 with respect to the frame 12.

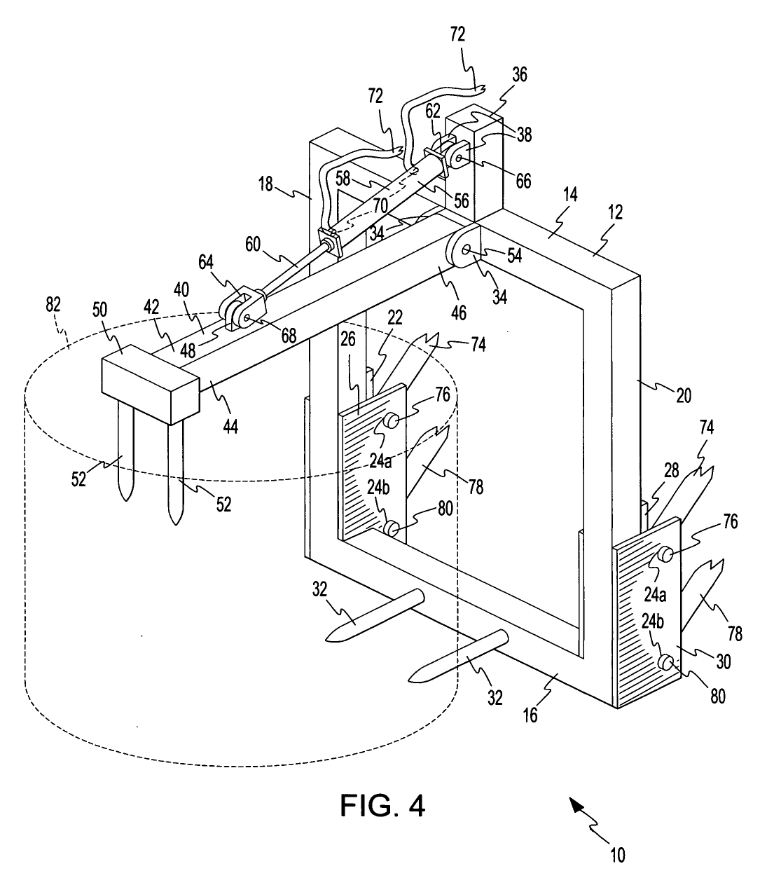

As shown in FIG. 4, the arm 40 is positioned substantially over and upon the top of the hay bale 82. The tines 52 attached to the tubular member 50 at the end of the arm 40 enter or otherwise penetrate the top of the hay bale 82. The hydraulic cylinder 56 continues to lower the arm 40 onto the hay bale 82 until facing sides of the tubular members 42, 50 of the arm 40 make contact with the top of the hay bale 82. At this point, the tines 32, 52 firmly grasp the hay bale 82 therebetween. The tractor fork can raise the hay grabber farm implement 10 with the hay bale 82 secured thereon above the ground or support surface or pivot the hay bale grabber farm implement 10 rearward upon the tubular members 74, 78 of the tractor fork and respective ends 76, 78 as described previously to transport, stack, and store one or more hay bales 82 to a second location for stacking and storage thereof.

The hay bale grabber farm implement 10 can grasp and pick up a hay bale 82 from any side for moving and transport. The implement 10 can also stack up to four hay bales 82 in a single column on flat sides thereof. This method of stacking will prevent the weight of the hay bales 82 from crushing or damaging each other 82 and save space within a storage area, such as a barn or other out building.

While this version of the invention has been illustrated and described in detail in the drawings and foregoing description, the same is to be considered as illustrative and not restrictive in character, it being understood that only the preferred embodiment has been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### CONCLUSION AND SCOPE OF INVENTION

From the foregoing, it will be understood by persons skilled in the art that an improved hay bale grabber farm implement has been provided. The invention is relatively simple and easy to manufacture, yet affords a variety of uses. While my description contains many specificities, these should not be construed as limitations on the scope of the version of the invention, but rather as an exemplification of the preferred embodiment thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

1. A method for stacking hay comprising of:
A) A square frame that mounts on the loader of a tractor
B) An arm that protrudes out from the top of said square frame with a hydraulic cylinder that operates the arm up and down on said square frame and
C) Has two spikes on the bottom of said square frame and on the arm that protrudes out from said square frame will also have two spikes
D) That whereby will penetrate the round bale of hay thereby letting the said square frame to be able to pick up the square bales of hay to be picked up and stacked.
